(19) United States
(12) Patent Application Publication
(10) Pub. No.: US 2025/0003781 A1
(43) Pub. Date: Jan. 2, 2025

(54) A REFILLABLE FLUID DISPENSER APPARATUS WITH IMPROVED DOSING

(71) Applicant: RESEARCH AND DEVELOPMENT APPS SOFTWARE TEKNOLOJI A.S., Avcilar/Istanbul (TR)

(72) Inventors: Volkan Evcil, Avcilar/Istanbul (TR); Yavuz Altun, Avcilar/Istanbul (TR)

(73) Assignee: RESEARCH AND DEVELOPMENT APPS SOFTWARE TEKNOLOJI A.S., Avcilar/Istanbul (TR)

(21) Appl. No.: 18/704,446

(22) PCT Filed: Sep. 8, 2022
(86) PCT No.: PCT/TR2022/050961

§ 371 Date: Apr. 24, 2024

(30) Foreign Application Priority Data
Dec. 6, 2021 (TR) 2021/019212

(51) Int. Cl. G01F 11/02; B65D 83/00

(52) U.S. Cl. CPC G01F 11/023; B65D 83/0011; G01F 11/025

(57) ABSTRACT

The invention relates to a refillable fluid dispenser apparatus with improved dose adjustment. The invention is characterized in that adjustment base (2.2) that enables dose adjustment by contacting the corresponding stopper (1.1) on the top side of the pressure cap (1), which is seen in FIG. 3 and a tube (2) with a shaft channel through which the shaft (5) moves the piston (3) back and forth, a pressure cap (1) that fits over this tube (2) and adjusts the forward or backward movement of the piston (3) by turning it to the right or left, and in which this movement is made by pressing on it, the piston (3), in which the movement taken from the pressure cap (1) is transmitted by the shaft (5), and the leaf spring (6) in contact with this shaft (5) is attached and released, determining the direction of movement of the shaft (5) are configured as seen in FIG. 1.

### TECHNICAL FIELD

The invention relates to a refillable fluid dispenser apparatus with improved dose adjustment.

### BACKGROUND ART

There are various packages that mediate the useage, serving and storage of fluid and semi-fluids such as ketchup, mayonnaise and similar sauces, personal care and health products such as hair gel, toothpaste, and various food products such as cream, hazelnut paste, and many apparatus specially made therefor. For example, a ketchup bottle can be used both as a product packaging and as a service tool. However, such tools are not refillable and the refillable ones are not useful enough. In particular, it causes various difficulties and obligations such as removing the cap for refilling, refilling the product inside by using a funnel, spoon and similar additional tools. Although the air entering these disposable or refilled packages prevents the product contained therein from deteriorating quickly, during the use of the product, while the squeezing process is performed, the air inside it suddenly goes out, causing the product to splash around undesirably.

In the patent application numbered TR 2018/05318, which should be mentioned in the state of the art, it is summarized as “Thanks to the easy-to-open cap structure created on the invention, it is related to the packaging that enables the fluid products (shampoo, hair conditioner, body cream, liquid adhesive materials, chemical materials used in construction and building products, food products such as ketchup, mayonnaise, mustard, olive oil, vinegar, lemon juice, etc.) in the package to be used for single use and to be transferred out in a controlled manner”.

In the utility model application numbered TR 2015 08857, which is another publication that should be mentioned in the state of the art, the invention is expressed as “The present invention regarding the packaging with nail skipping mechanism, which ensures that all kinds of fluid and semi-fluid products in liquid and cream form such as ketchup, mayonnaise, honey, toothpaste, hair dye, etc. are completely discharged from the package without wastage and a certain dose of product is taken from the package in each use (in all levels) generally consists of: Packaging body; Each time the user presses the plunger, a pusher with a gasket, which skips one step towards the cap on the nails on the pin, thus pushing the liquid or cream substance in the package body towards the cap, allowing a certain amount of the said substance to come out of the cap mouth; Gasket that allows the pusher to move through the package body without leaving any liquid or cream product residues and thus the liquid or cream products to be completely discharged from the package body without wastage; Flexible threaded base that allows the pusher with gasket to skip nail by one step over the moving pin when the user depresses the piston; Piston that allows the user to move the pin towards the cap and thus the pusher with gasket to skip nail by one step towards the cap; The spring that allows the piston to return to its original position after each compression; Spring base that provides compression of the spring when the piston is pressed; The pin with nail which moves towards the cap when the user presses the piston and which, in its reverse movement, provides pusher with gasket to skip nail by one step; The runner on the tip of the pin with nail, which ensures the smooth flow of the liquid or cream product from the cap mouth; cap gasket, which ensures that the packaging cap is kept clean all the time by scraping the liquid or cream product coming out of the cap mouth.

In the document with the publication number TR 2018/17543, which is a previous application of the applicant, the invention is described such that “It is the product dispenser that performs the function of dispensing in more than one measuring amount different from each other, which includes the product reservoir where ketchup, mayonnaise, cosmetics, cream and the products with similar fluidity are positioned, and a product pushing apparatus that performs the function of pushing the said product downwards in connection with the end of at least one shaft, characterized in that the said product dispenser includes a dose adjustment apparatus, which is connected to the product pushing apparatus over the mentioned shaft at its top point, and which allows the product to be dispensed in the desired measuring amount with its right-to-left movement, without need for using an extra measuring apparatus”.

In the document with the publication number TR 2018/17457, which is another application of the applicant, the invention is described such that “It is the fluid product dispenser device, which is used for the controlled pouring of liquid products such as ketchup, mayonnaise, oil, vinegar, is suitable for more than one use, has an airtight structure, and only performs the function of dispensing to the desired extent, characterized in that it includes the top cap, which is positioned at the highest point of the said fluid product dispenser device and which performs the control function of the said fluid product dispenser device with its right, left and down movements, fluid reservoir in which fluids such as ketchup, mayonnaise, oil, honey are placed, shaft housing that enables the said top cap to be positioned on the fluid reservoir, the shaft that is connected to the said shaft housing and that allows the fluid product in the fluid reservoir to be taken out and/or refilled by moving from the transverse part of the geometric shape to the depth part, and from the depth part to the transverse part, with the left and right movement of the upper cap, fluid pushing apparatus which is connected with the end of said shaft and pushes said fluid product downwards”.

In the document publishing number no. DE3338933 (A1), the dispenser for pasty products such as toothpaste, mustard or mayonnaise has a cylindrical housing for a piston that moves stepwise towards the nozzle provided at one end of the housing; it is connected by means of a rod pierced by a piston and a clamping barrier, moves on one side, thereupon, a spring-loaded bent arm that can rotate about a transverse axis in the restoring direction engages the piston rod. One arm of said bent arm extends transversely to the longitudinal axis of the dispenser and the other arm forming an operating arm extends parallel to the longitudinal axis of the housing. The dispenser also has a window-type opening in the housing wall of the housing for the bent arm to enter. In summary, “It is recommended that the window-type opening frames up the lateral surfaces of the limb parallel to the frame, in order to achieve a discharge operation that is simple to manufacture, convenient for allocation and risk-free”.

In publication number EP0242179 (A2) the invention is a positive displacement dispenser which is particularly useful in dispensing sticky material such as toothpaste. This dispenser has a chamber for the material to be dispensed, a discharge opening in the body through which the material is dispensed from the chamber, a threaded rod with an axis running through the chamber, a longitudinally extending housing defining a threaded piston. The opening mounted on the rod such that rotation of the rod moves the piston and the actuation lever and a swivel wheel axially mounted to the housing operatively combine the threaded rod and the actuation lever, so that pressing the actuation lever causes the wheel to rotate. The wheel, which can rotate when the threaded rod and its piston are carried forward, are coaxially mounted to the threaded rod and have a plurality of pins mounted in a circular path surrounding the axis of the wheel. A drive rod is attached to the actuation lever such that pressing the lever causes the drive rod to engage one of the pins and rotate the wheel by a fixed amount. is summarized as “A return spring, also connected to the actuation lever, returns the actuation lever to its original position and simultaneously pushes the drive rod against the pin next to it”.

### DESCRIPTION OF THE INVENTION

The present invention relates to a dose-adjusted fluid dispenser that pushes or retracts the piston to which it is attached and the fluid in the tube, of which the pushing forward or pulling back surfaces interact with the relevant surface of the leaf spring with the rotation of the pusher shaft inside the tube by rotating the upper adjustment mechanism and that allows it to make these movements at certain distances with its counterpart in the turning mechanism at the top of the tube.

The aim of the invention is to apply the fluid in the tube by means of a piston by using a pusher shaft in different geometric shapes in order to take out and/or pull in the fluid. Here, it is configured in such a way that the pusher shaft engages the corresponding surfaces of the leaf spring on the piston and is released by friction and, the up and down movement of the piston in the tube is provided by the interaction of the leaf spring fixed to the piston with the pusher shaft.

Another aim of the invention is to provide sealing for the fluid when the piston moves back and forth and rotates inside the pusher shaft, with a sealing gasket in the piston in which the pusher shaft pass.

Another aim of the invention is to increase the strength of the piston and to eliminate the deformations with the special shape and flexible structure of the inner section of the piston and the surfaces in contact with the inner surface of the tube.

Another aim of the invention is to use a plug at the end of the piston bottom surface of the pusher shaft to prevent the piston from coming out of the tube after discharge and to prevent the pusher shaft from releasing the piston. Thus, the exit of the piston at the last fulcrum point is prevented.

Another aim of the invention is to create a piston configuration in such a way that allows the piston to go back with an external force, even though the pressure cap on the tube is in the back position.

Another object of the invention is to provide at least one air hole under the pressure cap to allow air to be taken into the tube. The air taken into the tube does not come into contact with the product it contains. In addition, in the invention, the leaf valve in the outlet hole on the outlet cap at the bottom of the tube also prevents air entry into the product chamber. Thus, the deterioration time of the product isolated from the air is extended.

### BRIEF DESCRIPTION OF DRAWINGS

The embodiments of the present disclosure which are summarized above and discussed in more detail below can be better understood by referring to exemplary embodiments of the present disclosure illustrated in the accompanying drawings. It should be noted, however, that the accompanying drawings only describe the typical embodiments of the present disclosure, and thus, are not to be considered as limiting the scope of the present disclosure such that other effective embodiments may also be within the scope of the present disclosure.

FIG. 1 is the general view of the dispenser apparatus of the invention.

FIG. 2 is the a cross-sectional view of the dispenser apparatus of the invention.

FIG. 3 is an exploded view of the invention.

FIG. 4 is a cross-sectional view of the pressure cap.

FIG. 4a is the top view of the pressure cap.

FIG. 5 is a side, front sectional view of the shaft.

FIG. 6 is the front and top view of the piston.

FIG. 6a is the top view of the piston added with the gasket.

FIG. 6b is the top view of the piston added with gasket and leaf spring.

FIG. 7 is a side and top view of the leaf spring.

For ease of understanding, identical reference numerals are used where possible to indicate identical elements in the figures. Figures are not drawn to scale and can be simplified for clarity. It is contemplated that elements and features of an embodiment can be usefully incorporated into other embodiments without the need for further explanation.

### Description of Details in Drawings

Described herein are the reference numbers shown in the figures.
1—pressure cap
1.1—Stopper
1.2—Shaft housing
1.3—Spring
2—Tube
2.1—Shaft channel
2.2—Adjustment base
2.3—Tube mouth
3—Piston
3.1—Piston gasket
3.2—Shaft bearing
3.3—Spring bearing
3.4—Gasket bearing
3.5—Polygonal surface
3.6—Surface refraction
3.7—Wing
4—Outlet cap
4.1—Outlet
5—Shaft
5.1—Shaft plug
5.2—Drive surface
6—Leaf spring
6.1—Spring thread
6.2—Locking
6.3—Spring stretching

### DETAILED DESCRIPTION OF THE INVENTION

The preferred embodiment alternatives of the fluid dispenser of the invention, which are mentioned in this detailed description, are only intended for providing a better understanding of the subject-matter, and should not be construed in any restrictive sense.

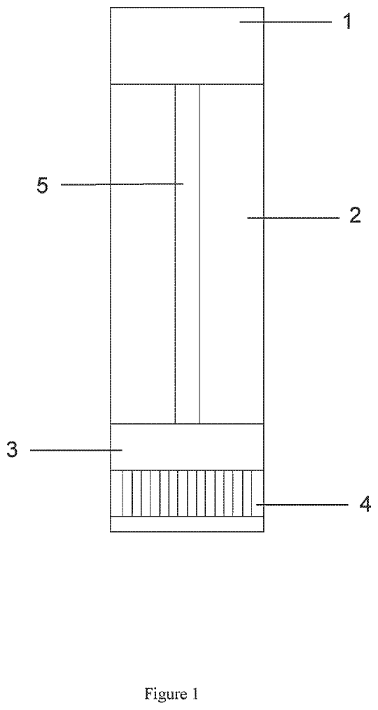

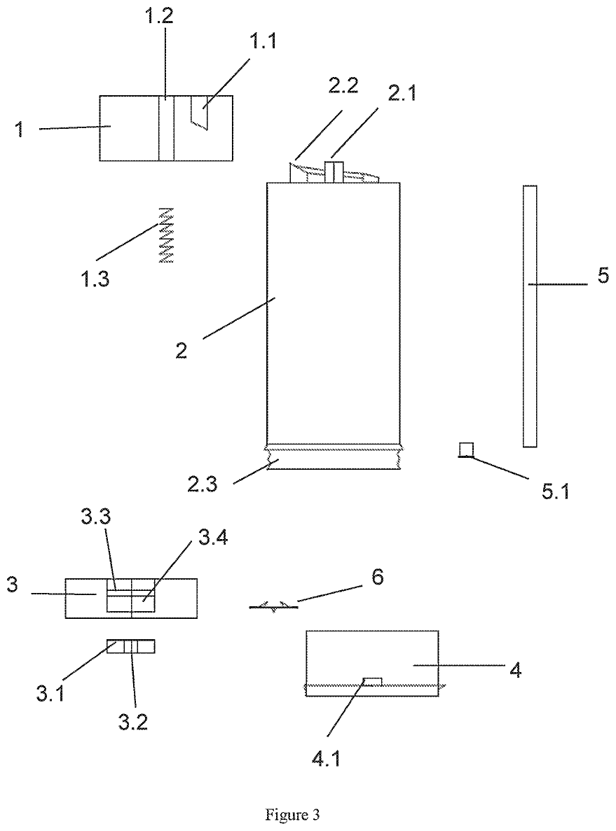

The invention is characterized in that adjustment base (2.2) that enables dose adjustment by contacting the corresponding stopper (1.1) on the top side of the pressure cap (1), which is seen in FIG. 3 and a tube (2) with a shaft channel through which the shaft (5) moves the piston (3) back and forth, a pressure cap (1) that fits over this tube (2) and adjusts the forward or backward movement of the piston (3) by turning it to the right or left, and in which this movement is made by pressing on it, the piston (3), in which the movement taken from the pressure cap (1) is transmitted by the shaft (5), and the leaf spring (6) in contact with this shaft (5) is attached and released, determining the direction of movement of the shaft (5) are configured as seen in FIG. 1.

As seen in FIG. 1, the invention is preferably a fluid distributor apparatus that enables the fluid in a transparent tube (2) to be adjusted to the forward or backward movement of the piston (3) by turning the pressure cap (1) on the tube (2) to the right or left, and the fluid product to exit or be withdrawn from the tube (2) by pressing and releasing this pressure cap (1).

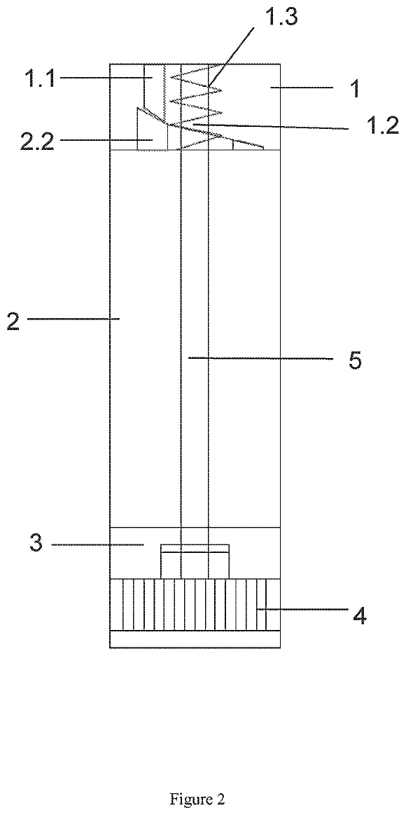

As seen in FIG. 2 in the invention, the shaft (5) connected to the pressure cap (1) is attached to the shaft housing (1.2). For the piston (3) movement, there is a compression spring (1.3) that brings the pressure cap (1) back after the pressing and releasing movement. The stopper (1.1) located on the inner surface of the discharge cap (1) is configured to adjust the dosage of the fluid product, wherein when the pressure cap (1) is turned, it contacts the upper surface of the adjustment base (2.2), which is on the upper side of the tube (2) and corresponds to the stopper (1.1). The adjustment base (2.2) is a crescent-shaped monolithic structure on the upper side of the tube (2), descending from a high end to a lower end. Herein, since whatever height the stopper (1.1) coincides with the surface of the adjusting base (2.2) when the pressure cap (1) is turned, it can be pressed as much when the pressure cap (1) is pressed, the shaft (5) and the piston (3) connected thereto will be provided to proceed in the tube (2) as much as that distance.

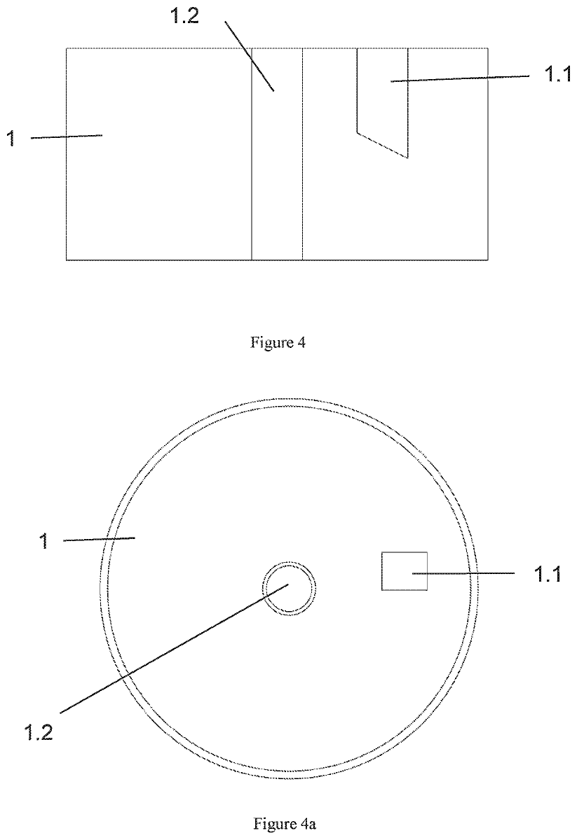

In the invention, as seen in FIG. 4 and FIG. 4a, there is a shaft housing (1.2) on the inner surface of the pressure cap (1). Even though there is a shaft (5) inside this shaft housing (1.2), it is attached to the shaft channel (2.1) on the tube (2) together with the spring (1.3). The stopper (1.1) on the inner surface of the pressure cap (1) can be applied in different shapes such as triangular or spherical in order to achieve the same purposes.

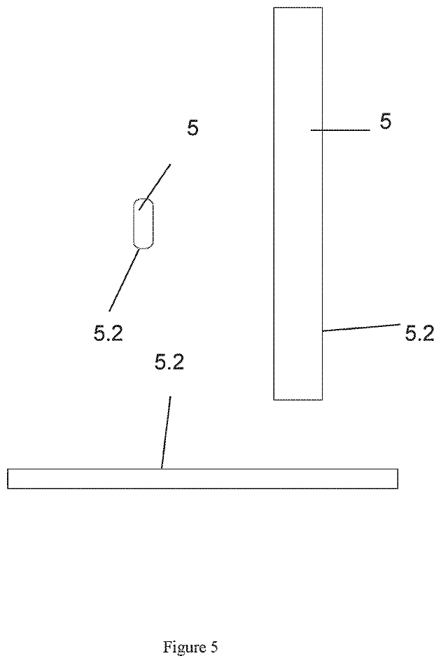

As can be seen in FIG. 5, a shaft (5) is used in the invention. Although a rectangular shaft (5) with rounded corners is shown here, the shaft (5) can also be used in different forms for the same purpose. As regards to the drive surfaces (5.2) located on the sides of the shaft (5), when the pressure cap (1) is pressed, the drive surface (5.2) of the shaft (5) connected thereto contacts the spring thread (6.1) in the leaf spring (6) inside the piston (3) and the locking (6.2) located at its end. If the pressure cap (1) is adjusted to the pushing direction, the shaft (5) has turned to the corresponding spring thread (6.1) in the leaf spring (6) and when pressed, the movement is transmitted to the leaf spring (6) by the shaft (5) and while the leaf spring (6) moves forward, the piston (3) to which it is attached also proceeds inside the tube (2). The locking (6.2) at the end of the spring thread (6.1) prevents the piston (3) from coming back after pressing. Due to the shape of the locking (6.2), it is prevented from going backwards when the shaft (5) clings to the drive surface (5.2). For the backward movement of the piston (3), the pressure cap (1) is brought to its back position and when it is pressed, the shaft (5) turns to the pulling back threads of the leaf spring (6). Thus, instead of the locks (6.2) that it is attached in the pushing forward process, in the pulling back process, the drive surface (5.2) of the shaft (5) is attached to the spring gears (6.1) in the other direction and to the locks (6.2) at their ends, preventing the forward movement in the pulling back movement. The shaft plug (5.1) located at the end of this shaft (5) fixed to the piston (3) is used at the end of the shaft (5) on the lower surface of the piston (3) to prevent the piston (3) from exiting the tube (2) after discharge and to prevent the shaft (5) from releasing the piston (3). Thus, the exit of the piston (3) at the last fulcrum point is also prevented.

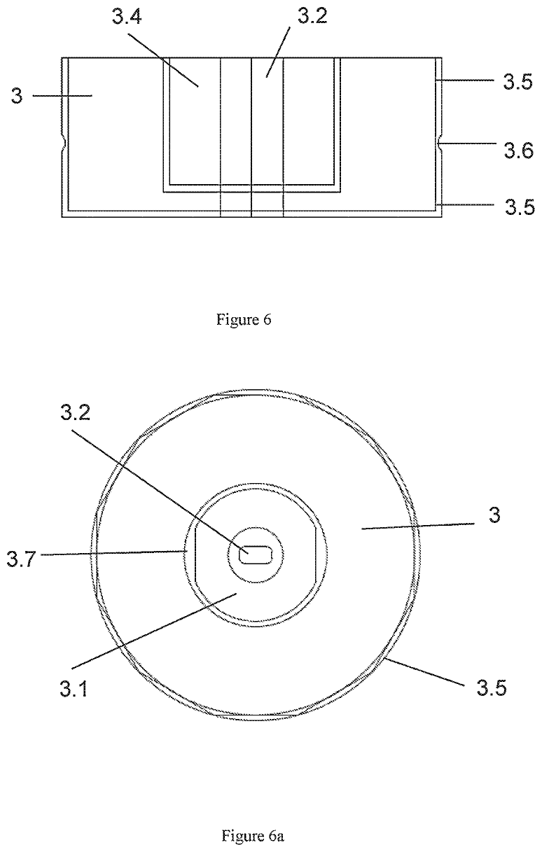

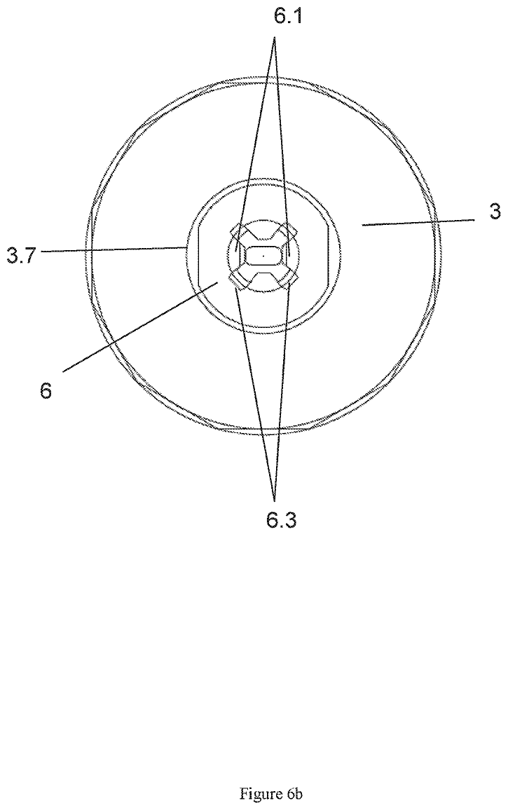

As seen in FIG. 6 in the invention, there are polygonal surfaces (3.5) on the surface of the piston (3) inside the tube (2), which is in contact with the inner surface, which complete each other at the top and bottom, allowing the piston (3) to form a sealed area on the entire surface, and surface refraction (3.6) between these polygonal surfaces (3.5). It includes leaf spring (6) and piston gasket (3.1), with a wall thickness that can be arranged in a way that does not prevent the piston (3) from fulfilling its function. As seen in FIG. 6a, a piston gasket (3.1) inside which the shaft (5) passes and which rotates together with the shaft (5) includes a gasket bearing (3.2). The leaf spring (6), which is placed in the spring bearing (3.3) on the piston gasket (3.1) placed in the gasket bearing (3.4) inside the piston (3), as seen in FIG. 6b, is compressed by the wings (3.7), thus its movement is prevented. The leaf spring (6) includes spring threads (6.1) configured to present at least one on its upper and lower sides, and spring stretching (6.3) for these spring threads (6.1) to stretch with the movement of the shaft (5), and locking (6.2) areas for locking the shaft drive surface (5.2).

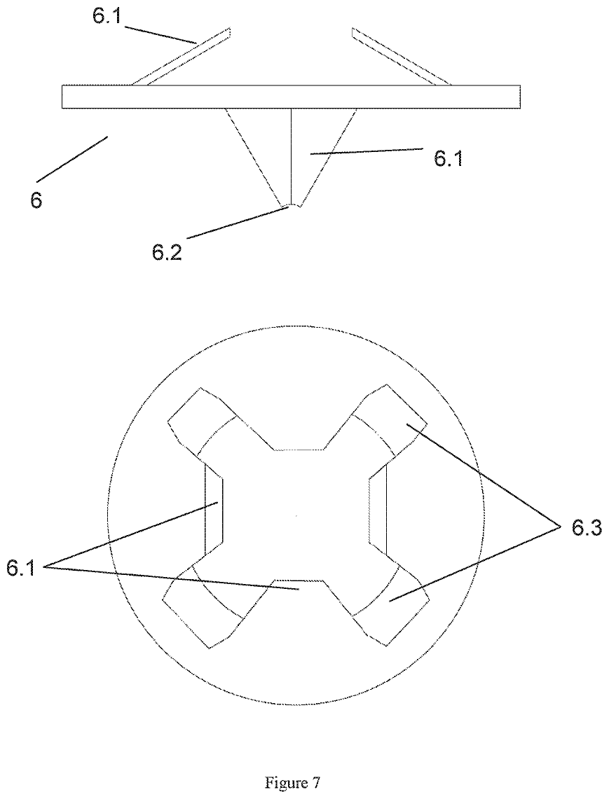

In the invention, FIG. 7 shows the detail of the leaf spring (6), which comes into contact with the drive surface (5.2) on the shaft (5) connected thereto and also moves the piston (3) to which it is attached, when the pressure cap (1) is pressed. Here, when the drive surface (5.2) of the shaft (5) comes into contact with the spring threads (6.1) facing upwards, the locks (6.2) at the ends of these threads (6.1) lock these drive surfaces (5.2) and allow the shaft (5) to press downwards. With this pressure of the shaft (5), which is compressed and motionless between the shaft housing (1.2) in the pressure cap (1) and the gasket bearing (3.2) in the piston (3), the leaf spring (6) and the piston (3) connected thereto move downwards and the movement of the fluid from inside of the tube (2) to outside of the tube (2) is ensured. When the drive surface (5.2) of the shaft (5) rotated by turning the pressure cap (1) comes into contact with the spring threads (6.1) facing downwards, the locks (6.2) at the ends of these threads (6.1) lock these drive surfaces (5.2) and allow the shaft (5) to press upwards. With this pressure of the shaft (5), which is compressed and motionless between the shaft housing (1.2) in the pressure cap (1) and the gasket bearing (3.2) in the piston (3), the leaf spring (6) and the piston (3) connected thereto move upwards and the movement of the fluid from outside of the tube (2) to inside of the tube (2) is ensured. The geometrical shapes of the shaft (5) and the drive surfaces (5.2) can be changed, and the spring threads (6.1) of the leaf spring (6) can be changed accordingly.

1. A fluid distributor apparatus that enables the fluid in a transparent tube to be adjusted to the forward or backward movement of the piston by turning the pressure cap on the tube to the right or left, and the fluid product to exit or be withdrawn from the tube by pressing and releasing this pressure cap, wherein the piston includes polygonal surfaces that complete each other at the top and bottom on the surface of the tube in contact with the inner surface, which ensures that the piston forms a sealed area on the entire surface, and surface refraction between these polygonal surfaces, leaf spring and piston gasket, with a wall thickness that can be arranged in a way that does not prevent the piston from fulfilling its function, a piston gasket and a gasket bearing through which the shaft passes and rotates with the shaft, leaf spring which is placed in the spring bearing on the piston gasket placed in the gasket bearing inside the piston and is compressed by the wings, through which its movement is prevented, spring threads of the leaf spring configured to present at least one on its upper and lower sides, spring stretching for these spring threads to stretch with the movement of the shaft, and locking areas for locking the shaft drive surface.

2. The apparatus according to claim 1, wherein the shaft is connected to the pressure cap and attached to the shaft housing, a compression spring that brings back the pressure cap after the pressing and releasing movement for the piston movement, the stopper located on the inner surface of the pressure cap are configured to adjust the dosage of the fluid product, wherein when the pressure cap is turned, the adjustment base on the upper side of the tube and corresponding to the stopper contacts its upper surface; the adjustment base is a crescent-shaped monolithic structure on the upper side of the tube, descending from a high end to a lower end; since whatever height the stopper coincides with the surface of the adjusting base when the pressure cap is turned, it can be pressed as much when the pressure cap is pressed, with the pressure of the shaft connected thereto, the piston is made to proceed in the tube as much as that distance.

3. The apparatus according to claim 1, wherein as regards to the drive surfaces located on the sides of the shaft, when the pressure cap is pressed, the drive surface of the shaft connected thereto contacts the spring thread in the leaf spring inside the piston and the locking located at its end; if the pressure cap is adjusted to the pushing direction, the shaft turns to the corresponding spring thread in the leaf spring and when pressed, the movement is transmitted to the leaf spring by the shaft, and as the leaf spring moves forward, it also proceeds the piston connected thereto inside the tube; due to the shape of the locking at the end of the spring thread, the return of the piston after compression is prevented by the attachment of the shaft to the driving surface; for the backward movement of the piston, the pressure cap is brought to its back position and when it is pressed, the shaft turns to the pulling back threads of the leaf spring, and instead of the locks that it is attached in the pushing forward process, in the pulling back process, the drive surface of the shaft is attached to the spring gears in the other direction and to the locks at their ends, preventing the forward movement in the pulling back movement.

4. The apparatus according to claim 1, wherein the shaft includes the shaft plug located at the end of this shaft fixed to the piston on the lower surface of the piston to prevent the piston from exiting the tube after discharge and to prevent the shaft from releasing the piston.

5. The apparatus according to claim 1, wherein when the shaft contacts the upward facing spring threads of the drive surface, locks at the ends of these threads lock these drive surfaces and allow the shaft to press down; with this pressure of the shaft, which is compressed and motionless between the shaft housing in the pressure cap and the gasket bearing in the piston, the leaf spring and the piston connected thereto move downwards and the movement of the fluid from inside of the tube to outside of the tube is ensured; when the pressure cap is turned and contacts the downward facing spring threads of the driving surface of the rotating shaft, locks at the ends of these threads lock these drive surfaces, and by allowing the shaft to press upwards, the shaft, which is compressed and motionless between the shaft housing in the pressure cap and the gasket bearing in the piston moves the leaf spring and the piston connected thereto upwards with this pressure, so that the fluid outside the tube is taken into the tube.

6. The apparatus according to claim 1, wherein the geometrical shapes of the shaft and the drive surfaces can be changed into triangles, pentagons and similar shapes in order to realize their purpose, and the spring threads of the leaf spring can be changed accordingly.
